(19) United States
(12) Patent Application Publication
(10) Pub. No.: US 2026/0258881 A1
(43) Pub. Date: Sep. 3, 2026

(54) FAIL-SAFE HYDRAULIC LINEAR ACTUATOR

(71) Applicant: Sayatva, LLC, Cypress, TX (US)

(72) Inventor: Gayathri Srinivasa Ragavan, Cypress, TX (US)

(21) Appl. No.: 19/551,338

(22) Filed: Feb. 26, 2026

Related U.S. Application Data
(60) Provisional application No. 63/765,235, filed on Feb. 28, 2025.

(51) Int. Cl. F16K 31/122

(52) U.S. Cl. CPC F16K 31/1221

(57) ABSTRACT

A hydraulic linear actuator for offshore and subsea applications includes a spring housing, a hydraulic cylinder with a piston, a stem connected to the piston, and a dual coil spring fail-safe assembly. The fail-safe assembly includes an outer spring and an inner spring disposed concentrically and connected in series by a spring lifter. The spring lifter has a top-hat configuration with a cylindrical wall, a closed top, and a flanged rim, allowing the springs to be compactly arranged concentrically while functioning in series. The spring lifter also prevents over-compression of both springs. A piston spacer between the piston and the fail-safe assembly permits the actuator stroke to be changed by substituting piston spacers of different heights without altering the springs, spring lifter, piston, or hydraulic cylinder. The inner spring provides redundant fail-safe force sufficient to actuate the valve upon failure of the outer spring.

### CROSS-REFERENCE TO RELATED APPLICATION AND PRIORITY CLAIM

This application claims the benefit of U.S. Provisional Application No. 63/765,235, entitled FAIL-SAFE HYDRAULIC LINEAR ACTUATOR, filed Feb. 28, 2025 (Attorney Docket No. SAYA60-35969), the entire disclosure of which is hereby incorporated by reference herein.

### TECHNICAL FIELD

The present invention relates to hydraulic linear actuators for operating valves and other devices, especially in offshore or subsea oil and gas applications. More specifically, the invention concerns a hydraulic linear actuator incorporating a dual coil spring fail-safe mechanism for ensuring reliable operation to a predetermined configuration in the event of power failure.

### BACKGROUND

Offshore and subsea environments demand robust and reliable equipment, particularly in oil and gas drilling and production operations where positive control of fluid flows is critical for ensuring safety and operational efficiency. Actuators play an essential role in operating valves and other device that regulate the flow of fluids through drill pipe and other conduits. In some cases, valves are fitted with actuators to allow operation by automated systems. In other cases, valves are situated underwater or in other locations inaccessible to human operators, thus requiring actuators to allow remote operation. Actuators for critical roles need a reliable fail-safe mechanism to automatically return the actuator (and thus the attached valve) to a predetermined safe condition in the event of control line breaks, power failures or other emergencies.

Hydraulic linear actuators are known for operating oil and gas equipment such as gate valves and other flow-control devices. Some hydraulic linear actuators include single spring fail-safe mechanisms; however, such mechanisms can be prone to wear, failure, and insufficient force under certain operating conditions. Therefore, there is a need for a more reliable fail-safe actuator that ensures safe operation during emergencies, offering redundancy and greater force to ensure the valve is returned to a safe position in case of a hydraulic leak or failure.

Valves of several different sizes, each size having its own stroke length and operating force, may be present in at a single oil and gas location or facility. Linear actuators for such valves must have compatible stroke lengths and operating forces. Existing linear actuators designs typically utilize different length housings and internal components for each different stroke. Therefore facilities having many different sizes of valves must typically maintain many different lengths of actuators in its inventory, which can be expensive and take up valuable space in an offshore facility. Therefore, there is a need for an actuator having a single housing length that can be fitted to valves requiring a range of different strokes.

### SUMMARY

The invention is directed to an offshore valve actuator equipped with a dual coil spring fail-safe mechanism. The actuator is designed to provide a fail-safe response to power loss, using two coil springs to ensure reliable valve closure (or opening, depending on the fail-safe configuration of the valve) under extreme offshore conditions.

The dual coil spring system provides redundancy, allowing the actuator to function even if one of the springs fails to move. In addition, the use of two springs offers a greater stored energy potential, providing enhanced force to actuate the valve during emergencies. The actuator can be configured for different strokes through the use of modular components, depending on the specific application needs.

Put simply, the actuator operates using hydraulic pressure to move a piston controlling the position of a stem connected to a valve gate. Under normal operating conditions, pressure from an external hydraulic power source compresses the dual springs of the fail-safe assembly as the piston moves upward to open the attached valve. In the event of a power failure, the spring energy stored in the fail-safe assembly is released, moving the piston downward to a pre-set position and closing the valve.

In preferred embodiments of the actuator, the fail-safe assembly includes dual springs comprising a secondary spring positioned concentrically withing a primary spring, wherein the two springs are mechanically connected in series. By varying the parameters of each spring, the total nominal force of the actuator (i.e., the actuator closing force available when both springs are functioning normally) and the reserve force (i.e., the actuator closing forces available when one spring of the dual springs fails) can be selected to meet different requirements without changing the external form factor of the actuator.

In preferred embodiments of the actuator, the overall stroke of the actuator can be set using a piston spacer positioned between the piston and the fail-safe assembly. By varying the height of the piston spacer, the stroke of the actuator can be selected to meet different requirements without changing the external form factor of the actuator.

Components of the fail-safe assembly include a primary spring and a secondary spring. The primary spring is preferably a coil spring and is typically designed to provide a greater portion of the fail-safe force. Its specifications are selected based on the operational requirements of the valve (i.e., the force and stroke required to close or open the valve). The secondary spring is preferably a coil spring, but alternatively could be a different type of spring, e.g., a gas spring, a stack of Belleville-type disc washer springs, etc., having a form factor that allows it to be disposed within the coils of the primary spring. The secondary spring typically serves as a backup to the primary spring and adds redundancy. Should the primary spring fail or degrade over time, the secondary spring ensures that the actuator remains capable of fail-safe operation.

The dual spring configuration ensures that the actuator can generate sufficient force, over a sufficient distance, to actuate the valve to its fail-safe configuration, even in challenging offshore conditions, such as high pressure or deep-water environments.

The configuration of the disclosed actuator is ideal for critical offshore applications where operational safety and reliability are paramount. The actuator can be configured for either fail-closed or fail-open operation depending on the requirements of the specific valve system.

In one aspect, a valve actuator for offshore applications comprises a housing, a piston assembly coupled to a valve stem, and a dual coil spring assembly coupled to the piston assembly. The dual coil spring assembly is configured to provide fail-safe operation when there is a power failure of the piston assembly.

In one embodiment, the dual coil spring assembly includes a primary coil spring and a secondary coil spring, with the secondary coil spring providing redundancy when there is a failure of the primary coil spring.

In another embodiment, the valve actuator further comprises a hydraulic or pneumatic power source for operating the piston assembly under normal conditions and a fail-safe mechanism that actuates the valve when there is a loss of power from the hydraulic or pneumatic power source.

In another aspect, a valve actuator is provided for attachment to a gate valve having a bonnet, a flow bore and a gate, wherein the gate can be selectively moved between an open position, allowing fluid flow through the flow bore, and a closed position, blocking fluid flow through the flow bore. The valve actuator comprises a spring housing defining a central axis and adapted for connection to a gate valve, a piston chamber disposed within the spring housing, and a piston slidingly mounted within the piston chamber and adapted to selectively move along the central axis between a lower limit and an upper limit defining a stroke distance S_{P}. A stem is operably attached between the piston and a gate of the gate valve, whereby selective movement of the piston back and forth along the central axis causes identical movement of the stem and gate. A piston spacer has an upper surface and a lower surface defining a height H_{S} therebetween, wherein the lower surface is operably connected to the piston to move along the central axis with the piston. A fail-safe assembly is disposed within the spring housing including: an outer spring disposed within the spring housing having a first end and a second end positioned along the central axis, wherein the first end of the outer spring contacts a fixed portion of the spring housing. An inner spring is disposed concentrically within the outer spring and having a first end and a second end positioned along the central axis, wherein the first end of the inner spring is operably connected in series to the second end of the outer spring and the second end of the inner spring is operably connected to the upper surface of the piston spacer. When the piston spacer has a first height H_{S1}, the piston and stem have a first maximum stroke S_{P1}, and when the piston spacer has a second height H_{S2}>H_{S1}, the piston and stem have a second maximum stroke S_{P2}<S_{P1}.

### BRIEF DESCRIPTION OF THE DRAWINGS

For a more complete understanding, reference is now made to the following description taken in conjunction with the accompanying Drawings in which:

FIG. 1 is a perspective view of a fail-safe hydraulic linear actuator in accordance with a first aspect;

FIG. 2 is a side view of the actuator of FIG. 1;

FIG. 3 is a partial cross-sectional side view of the actuator of FIG. 1 in the OPEN configuration, cut as indicated by lines A-A in FIG. 1;

FIG. 4 is a cross-sectional side view of the actuator of FIG. 1 in the OPEN configuration, cut as indicated by lines B-B in FIG. 1; and

FIG. 5 is a cross-sectional side view of the actuator of FIG. 1 in the CLOSED configuration, cut as indicated by lines B-B in FIG. 1.

### DETAILED DESCRIPTION

Referring now to the drawings, wherein like reference numbers are used herein to designate like elements throughout, the various views and embodiments of a fail-safe hydraulic linear actuator are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments. References to directions such as up/upper/upwards, down/lower/downwards, and the like refer to the orientation of the components shown in the figures, and should not be considered limiting. It will be readily understood that the apparatus described herein can be used in any orientation, including vertical, horizontal, inverted and in-between orientations.

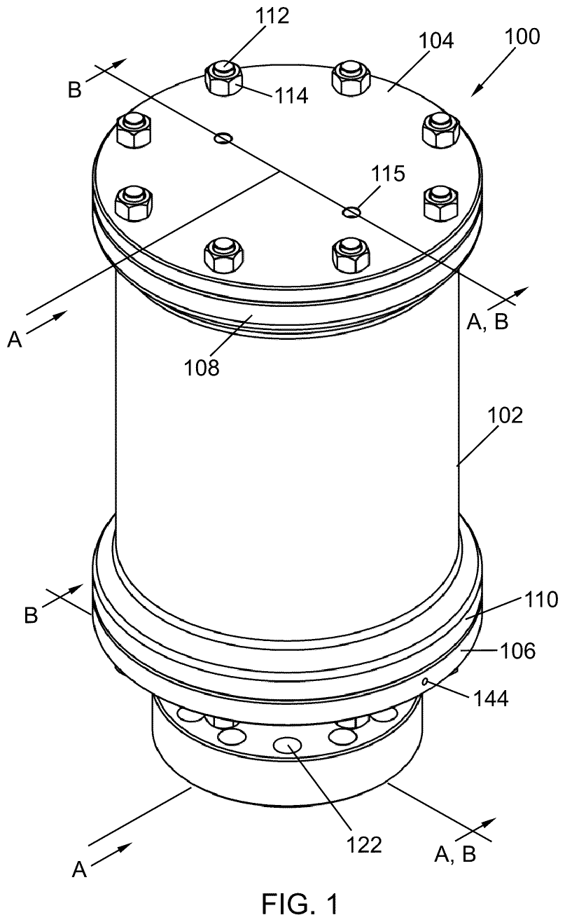

Referring now to FIG. 1, there is illustrated a fail-safe hydraulic linear actuator in accordance with one aspect. In the illustrated embodiment, the actuator 100 is adapted to operate a gate valve, however, other embodiments of the actuator can be adapted to operate other types of valves or devices requiring linear movement. The actuator 100 includes a cylindrical spring housing 102 having an upper end covered by an actuator cap 104. A lower end of the spring housing 102 is adapted for attachment to a valve bonnet 106. In some cases, the valve bonnet 106 is an original component of the gate valve, whereas in other cases, the valve bonnet is a provided as part of the actuator 100 to facilitate mounting the actuator to a particular model of gate valve (i.e., by replacing the valve's original bonnet). In the embodiment shown, the spring housing 102 includes thickened ring portions 108, 110 disposed at each end, which can be drilled and tapped to receive threaded studs 112. The studs 112 can be used for removably securing the cap 104 and bonnet 106 to the spring housing 102 using nuts 114. The actuator cap 104 can be provided with tapped holes or lifting points 115 to receive a lifting eye bolt to facilitate lifting the actuator.

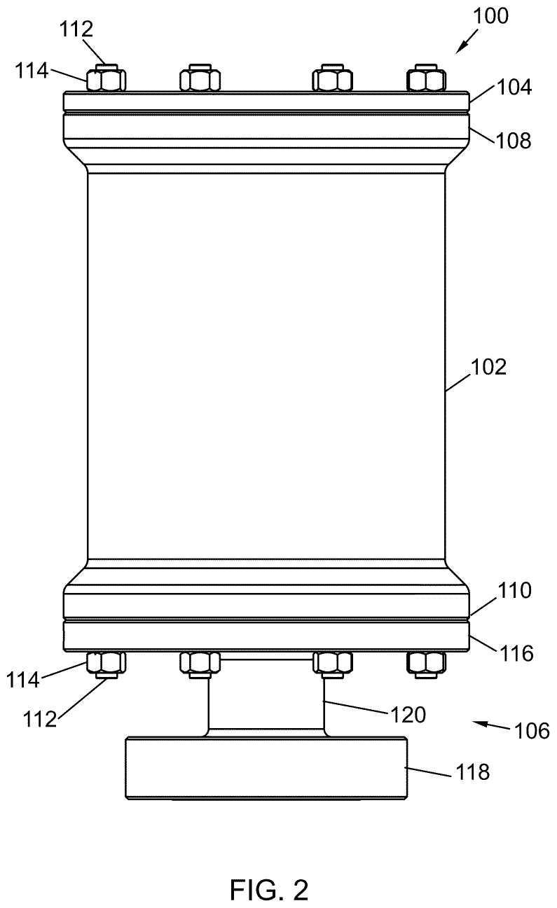

Referring now to FIG. 2, there is illustrated a side view of the fail-safe hydraulic linear actuator 100. In FIG. 2, it can be seen that the valve bonnet 106 can be configured as a flanged spool having an upper flange portion 116 and a lower flange portion 118 connected by a central stem guide 120. The upper flange portion 116 is adapted for connection to the lower end of the spring housing 102, e.g., using the studs 112 and nuts 114, and the lower flange portion 118 is adapted for connection to the remainder of the gate valve (not shown), e.g., with flange holes 122.

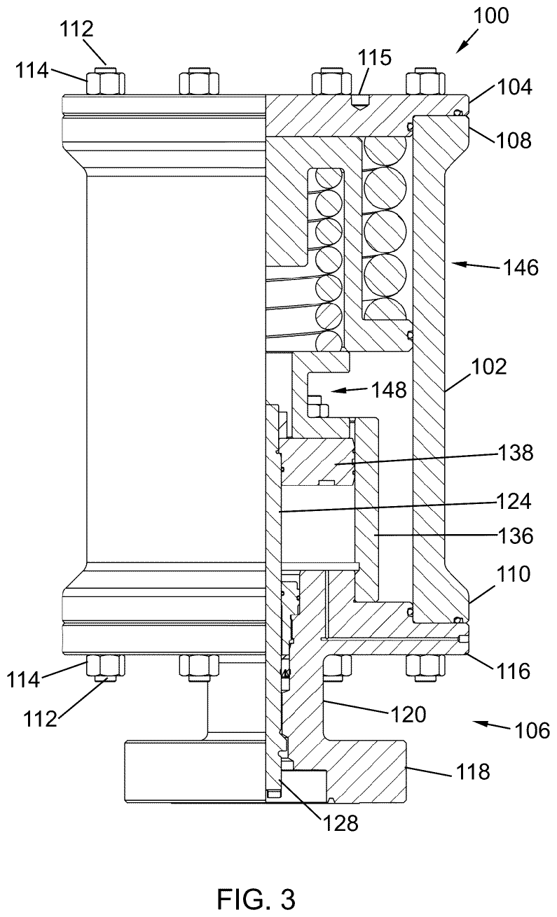

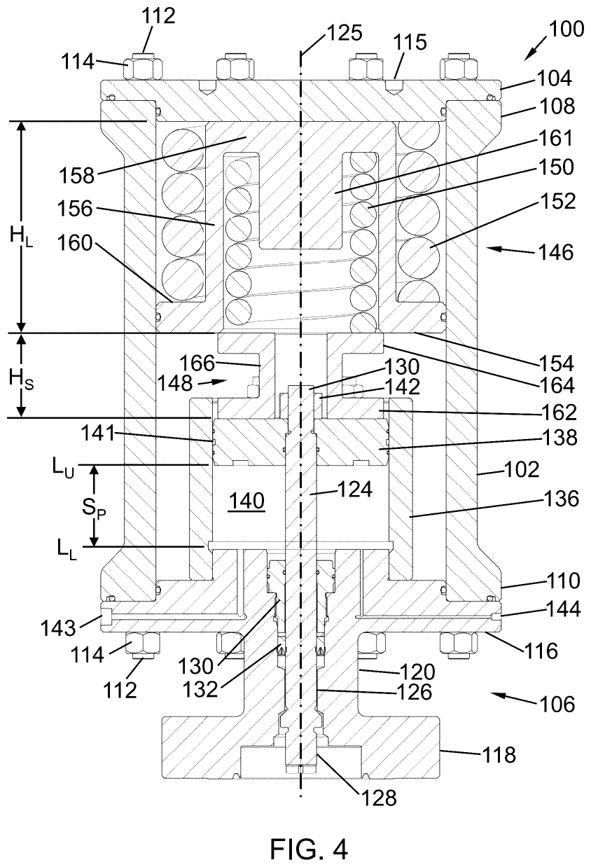

Referring now to FIGS. 3 and 4, there is illustrated a partial cross section (FIG. 3) and a full cross section (FIG. 4) of the fail-safe hydraulic linear actuator 100 in a first configuration wherein the stem 124 is retracted to its highest position. The “stem retracted” configuration shown in FIGS. 3, 4 corresponds to the OPEN configuration (also called OPEN position) for a conventional gate valve, wherein the stem 124 connected to the gate (not shown) is raised to align the gate port of the valve with the flow bore of the valve to allow fluid flow through the valve.

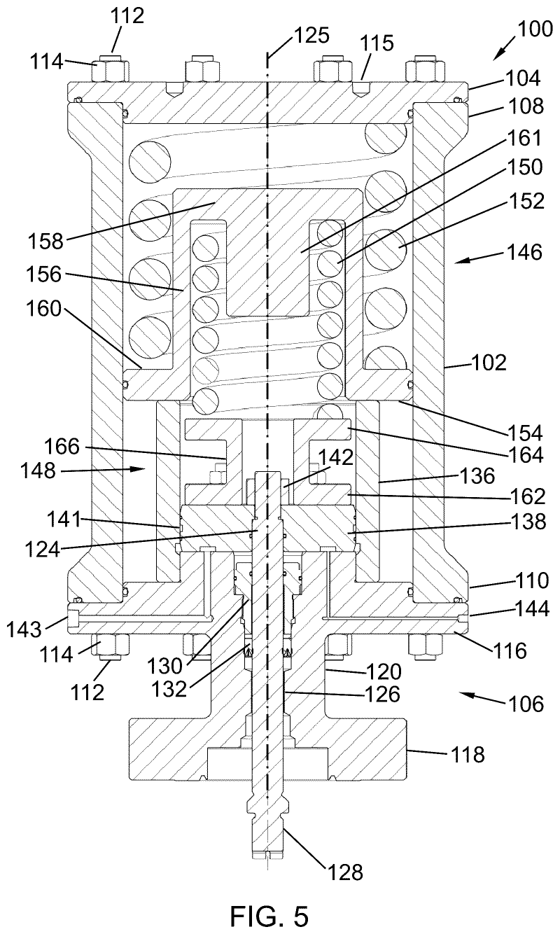

Referring now also to FIG. 5, there is illustrated a full cross section of the fail-safe hydraulic linear actuator 100 in a second configuration wherein the stem 124 is extended to its lowest position. The “stem extended” configuration shown in FIG. 5 corresponds to the CLOSED configuration (also called CLOSED position) for a conventional gate valve, wherein the stem 124 connected to the gate is lowered to move the gate port out of alignment with the flow bore to block fluid flow through the valve.

As best seen in FIGS. 4 and 5, the spring housing 102 defines a central axis 125, and the piston 138, stem 124 and fail-safe assembly 146 move along this central axis during operation of the actuator. Typically, the central axis 125 of the actuator will be aligned with the central axis of the gate valve. The bonnet 106 defines a stem passage 126 therethrough, which receives the stem 124. The stem 124 has a lower end 128 disposed beneath the bonnet 106 and an upper end 130 disposed above the bonnet within the spring housing 102. The stem lower end 128 is connected (directly or indirectly) to the gate of the gate valve for raising and lowering the gate within the valve body to control fluid flow as previously described. Annular stem seals 132 and stem packing 134 can be provided in the stem passage 126 to support the stem 124 and prevent fluid leakage through the stem passage while still allowing sliding movement of the stem.

Referring still to FIGS. 4 and 5, disposed inside the spring housing 102 is a hydraulic cylinder 136 fitted with a hydraulic piston 138. The cylinder 136 comprises an annular wall disposed on the upper side of the bonnet 106, and the piston 138 is slidingly mounted inside the cylinder, thereby creating a hydraulic chamber 140 beneath the piston. Seals 141 can be provided around the periphery of the piston 138 to prevent leakage from the hydraulic chamber 140. The stem 124 is attached to the piston 138 so that moving the piston up and down through its stroke will also cause the stem to move up and down by a like amount. In the illustrated embodiment, the upper end 130 of the stem 124 passes through a hole in the piston 138 until corresponding shoulders on the stem and piston abut one another, and is retained by a removable key 142 passing laterally through the stem; however, in other embodiments the stem can be attached to the piston using pins, threaded fasteners or other means. A fluid supply port 143 is provided connecting the hydraulic chamber 140 to the exterior of the actuator 100 for adding and removing hydraulic fluid to/from the hydraulic chamber 140. Adding hydraulic fluid to the chamber 140 pushes the piston 138 upwards along with the attached stem 124, while removing hydraulic fluid from the chamber allows the piston and stem to move downwards. A pressure relief port 144 can be provided connecting the hydraulic chamber 140 to the exterior of the actuator 100 for releasing hydraulic fluid when the pressure in the chamber exceeds a predetermined pressure.

A dual coil spring fail-safe assembly 146 is disposed in the upper portion of the spring housing 102, and a piston spacer 148 having a height (denoted “H_{S}”) is attached to the upper side of the piston 138 to span the distance between the piston and the fail-safe assembly. The fail-safe assembly 146 provides a downward-acting force on the piston 138 (i.e., transmitted via the spacer 148) to constantly bias the piston (and the attached stem 124) towards the stem extended (i.e., CLOSED) configuration shown in FIG. 5. To be clear, the fail-safe assembly 146 does not bias the piston 138 with a constant value of force, but instead it constantly biases the piston with sufficient downward force to ensure the actuator will extend the stem 124 and shut an attached gate valve upon loss of hydraulic power or fluid to the actuator.

To open an attached gate valve, the actuator 100 is activated in the “OPEN” direction by adding hydraulic fluid into the hydraulic chamber 140 via supply port 143 at sufficient pressure until the upward force below the piston 138 overcomes the downward bias of the fail-safe assembly 146, thereby causing the piston to move upward and retract the stem 124 until it reaches the OPEN configuration of FIG. 4. To close an attached gate valve under normal circumstances, the actuator 100 is activated in the “CLOSE” direction by withdrawing fluid from the hydraulic chamber 140 via the supply port 143, allowing the downward bias of the fail-safe assembly 146 to push the piston 138 downward and extend the stem 124 until it reaches the CLOSED configuration of FIG. 5. Under emergency conditions, such as loss of hydraulic power, a break in the hydraulic line feeding the supply port 143, or an overpressure situation that opens the pressure relief port 144, the bias of the fail-safe assembly 146 will ensure that the piston 138 and stem 124 move downward with sufficient force to expel the fluid under the piston and extend the stem until it reaches the CLOSED configuration of FIG. 5.

Referring still to FIGS. 4 and 5, the dual coil spring fail-safe assembly 146 comprises an inner coil spring 150, an outer coil spring 152 and a spring lifter 154 that allows the two springs to be physically disposed in a concentric arrangement while being functionally (i.e., mechanically) connected in series. This arrangement provides a powerful, yet compact arrangement that reduces the long travel typically associate with springs connected in series. It further allows either spring 150, 152 to move the piston 138 and stem 124 through its full range of motion (albeit with reduced force) if the other spring breaks or fails to expand.

In the illustrated embodiment, the spring lifter 154 has a configuration resembling a top hat, with a hollow cylindrical central wall portion 156, a closed top 158, and flanged rim 160 extending from the bottom edge of the central portion. The spring lifter 154 is adapted such that the central wall portion 156 has an outer diameter less than the inner diameter of the outer spring 152, the flanged rim 160 has an outer diameter greater than the outer diameter of the outer spring, and the height of the spring lifter from the upper surface of the flanged rim to the top of the closed top 158 is greater than the minimum height of the outer spring (i.e., the height at which the coils touch one another). This configuration of the spring lifter 154 allows the outer spring 152 to be compressed between the lower (i.e., inner) side of the actuator cap 104 and the upper side of the flanged rim 160, while the central wall portion 156 acts as a spring guide for the outer spring and prevents it from being over-compressed.

The spring lifter 154 is further adapted such that the central wall portion 156 has an inner diameter greater than the outer diameter of the inner spring 150, and the height of the spring lifter from the bottom of the flanged rim 160 to the inner surface of the closed top 158 is greater than the minimum height of the inner spring (i.e., the height at which the coils touch one another). Optionally, the spring lifter 154 can include an inner spring guide 161 extending from the inner side of the closed top 158 and having an outer diameter that is less than the inner diameter of the inner spring 150, which can act as a spring guide for the inner spring. This configuration of the spring lifter 154 allows the inner spring 150 to be compressed between the lower (i.e., inner) side of the closed top 158 and the upper side of the piston spacer 148 and prevents it from being over-compressed (because compression stops when the lower side of the flanged rim 160 reaches the uppermost side of the piston spacer).

The piston spacer 148 is preferably configured in a spool configuration having a lower flange 162 to facilitate connection to the piston 138 and an upper flange 164 configured to interface with the inner spring 150 and the spring lifter 154. The lower flange 162 and upper flange 164 can be connected by a central body 166 sized to give the piston spacer 148 the desired overall height H_{S}. In the illustrated embodiment, the piston spacer 148 defines a central passage to accommodate the upper end 130 of the stem and the key 142. In the illustrated embodiment, the upper flange 164 of the piston spacer 148 has an outer diameter that is greater than the inner diameter of the central wall portion 156 at the flange 160, such that the upper surface of the piston spacer will hit the bottom of the spring lifter rather than move into the interior of the spring lifter.

The stroke (denoted “S_{P}”) of the actuator 100 is defined by the distance traveled by the piston 138 between the upper and lower limits of its movement in the hydraulic cylinder 136. In the illustrated embodiment, the lower limit (denoted “L_{L}”) of the piston's movement is reached when the piston contacts the upper surface of the bonnet 106 at the bottom of the hydraulic chamber 140 (see FIG. 5), and the upper limit (denoted “L_{U}”) of the piston's movement is reached when the top of the spring lifter 154 contacts the inner surface of the actuator cap 104 (see FIG. 4). This upper limit is determined by the sum of the overall height of the spring lifter 154 (denoted “H_{L}”) (e.g., from the bottom of the flange 160 to the top of the closed top 158) plus the overall height of the piston spacer 148 (denoted “H_{S}”) (i.e., from the bottom of the lower flange 162 to the top of the upper flange164). Thus, by installing different piston spacers 148 having different heights H_{S}, the stroke S_{P} of the actuator 100 can be changed without changing the piston 138, cylinder 136, spring lifter 154 or springs 150 and 152.

As previously described, the use of the spring lifter 154 allows the inner spring 150 and outer spring 152 to be connected in series between the actuator cap 104 and the piston spacer 148. In particular, the upper end of outer spring 152 pushes against the actuator cap 104 and extends to a lower end pushing against the spring lifter flange 160, which flange is rigidly connected via the lifter wall 156 to the closed top 158 (and thus displaces identically), essentially connecting the lower end of the outer spring to the upper end of the inner spring 150 that pushes against the closed top and extends to its lower end pushing against the piston spacer.

The outer spring 152 of the fail-safe assembly 146 can also be called the “primary” spring, and the inner spring 150 of the fail-safe assembly 146 can also be called the “secondary” spring. The primary spring 152 is preferably a coil spring, but alternatively can be a different type of spring, e.g., a volute spring, a stack of Belleville-type disc washer springs, etc., having an open interior space to accommodate the secondary spring 150. The primary spring 152 is typically designed to provide a greater portion of the overall fail-safe force. Its specifications are selected based on the operational requirements of the valve (i.e., the force and stroke required to close or open the valve). The secondary spring 150 is preferably a coil spring, but alternatively could be a different type of spring, e.g., a gas spring, a stack of Belleville-type disc washer springs, etc., having a form factor that allows it to be disposed within primary spring 152. The force of the secondary spring 150 typically serves as a backup or adjunct to the force of the primary spring 152 and adds redundancy. Should the primary spring 152 fail or degrade over time, the secondary spring 150 ensures that the actuator 100 remains capable of fail-safe operation.

The dual spring configuration of the fail-safe assembly 146 ensures that the actuator 100 can generate sufficient force, over a sufficient distance, to actuate the attached valve to its predetermined safe configuration upon the loss of power or control, even in challenging offshore conditions, such as high pressure or deep-water environments.

In one embodiment, the actuator 100 can be configured for FAIL CLOSED operation and have spring parameters in the fail-safe assembly 146 as shown in Table 1 below:

TABLE 1
Example of spring parameters for fail-safe assembly.

| Parameter | Outer Spring | Inner Spring | Total |
|---|---|---|---|
| Material of spring | 5160 HRc 48 | 5160 HRc 48 | |
| | (as rolled) | (as rolled) | |
| Diameter (of coil | 2.000 | 1.250 | |
| wire) (in.) | | | |
| Inside diameter | 9.375 | 4.750 | |
| of coil (in.) | | | |
| Outside diameter | 13.375 | 7.250 | |
| of coil (in.) | | | |
| Spring free height (in.) | 12.750 | 12.750 | |
| Spring rate (lbs/in.) | 6,952.50 | 3,296.25 | |
| Spring height with | 11.86 | 9.60 | piston stroke @ |
| actuator CLOSED (stem | | | min = 0 in. |
| extended)(in.) | | | |
| Spring force with | 5,867.33 | 10,383.19 | 16,250.51 |
| actuator CLOSED (lbs.) | | | |
| Spring height with | 8.71 | 8.71 | piston stroke @ |
| actuator OPEN (stem | | | max = 4.045 in. |
| retracted) (in.) | | | |
| Spring force with | 26,633.70 | 13,330.28 | 39,950.55 |
| actuator OPEN (lbs.) | | | |

The actuator housing and components can be formed from corrosion-resistant materials suitable for offshore environments, such as stainless steel or specially coated metals, ensuring durability and long service life in harsh conditions. In one embodiment, the springs 150 and 152 are coil springs formed from Alloy Steel 5160 (also known as AISI 5160 and 5160 spring steel).

It will be appreciated by those skilled in the art having the benefit of this disclosure that this fail-safe hydraulic linear actuator provides reliable actuation and redundant fail-safe operation in a compact form factor. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A valve actuator for offshore applications, comprising a housing, a piston assembly coupled to a valve stem, and a dual coil spring assembly coupled to the piston assembly, wherein the dual coil spring assembly is configured to provide fail-safe operation when there is a power failure of the piston assembly.

2. The valve actuator of claim 1, wherein the dual coil spring assembly includes a primary coil spring and a secondary coil spring, with the secondary coil spring providing redundancy when there is a failure of the primary coil spring.

3. The valve actuator of claim 1, further comprising a hydraulic or pneumatic power source for operating the piston assembly under normal conditions and a fail-safe mechanism that actuates the valve when there is a loss of power from the hydraulic or pneumatic power source.

4. A valve actuator for attachment to a gate valve having a bonnet, a flow bore and a gate, wherein the gate can be selectively moved between an open position, allowing fluid flow through the flow bore, and a closed position, blocking fluid flow through the flow bore, the valve actuator comprising:
a spring housing defining a central axis and adapted for connection to a gate valve;
a piston chamber disposed within the spring housing;
a piston slidingly mounted within the piston chamber and adapted to selectively move along the central axis between a lower limit and an upper limit defining a stroke distance SP;
a stem operably attached between the piston and a gate of the gate valve, whereby selective movement of the piston back and forth along the central axis causes identical movement of the stem and gate;
a piston spacer having an upper surface and a lower surface defining a height H_{S} therebetween, wherein the lower surface is operably connected to the piston to move along the central axis with the piston;
a fail-safe assembly disposed within the spring housing including:
an outer spring disposed within the spring housing having a first end and a second end positioned along the central axis, wherein the first end of the outer spring contacts a fixed portion of the spring housing;
an inner spring disposed concentrically within the outer spring and having a first end and a second end positioned along the central axis, wherein the first end of the inner spring is operably connected in series to the second end of the outer spring and the second end of the inner spring is operably connected to the upper surface of the piston spacer;
wherein when the piston spacer has a first height H_{S1}, the piston and stem have a first maximum stroke S_{P1}; and
wherein when the piston spacer has a second height H_{S2}>H_{S1}, the piston and stem have a second maximum stroke S_{P2}<S_{P1}.

5. The valve actuator of claim 4, further comprising a spring lifter disposed within the spring housing and configured to operably connect the outer spring and the inner spring in series while the outer spring and the inner spring are disposed in a concentric arrangement.

6. The valve actuator of claim 5, wherein the spring lifter further comprises:
a hollow cylindrical central wall portion,
a closed top, and
a flanged rim extending from a bottom edge of the central wall portion,
the flanged rim having an outer diameter greater than an outer diameter of the outer spring, and the central wall portion having an outer diameter less than an inner diameter of the outer spring, and
wherein the outer spring is compressible between a fixed portion of the spring housing and an upper surface of the flanged rim while the central wall portion acts as a spring guide for the outer spring.

7. The valve actuator of claim 6, wherein the central wall portion of the spring lifter has an inner diameter greater than an outer diameter of the inner spring, and the inner spring is compressible between an inner surface of the closed top of the spring lifter and the upper surface of the piston spacer.

8. The valve actuator of claim 6, further comprising:
wherein a first height of the spring lifter from the upper surface of the flanged rim to a top surface of the closed top is greater than a minimum height of the outer spring at which coils of the outer spring contact one another, whereby over-compression of the outer spring is prevented, and
wherein a second height of the spring lifter from a bottom of the flanged rim to the inner surface of the closed top is greater than a minimum height of the inner spring at which coils of the inner spring contact one another, whereby over-compression of the inner spring is prevented.

9. The valve actuator of claim 5, wherein the upper limit of the piston is reached when a top surface of the spring lifter contacts an inner surface of an actuator cap secured to an upper end of the spring housing, and the stroke distance S_{P} is determined by a sum of an overall height of the spring lifter and the height H_{S} of the piston spacer.

10. The valve actuator of claim 5, wherein the piston spacer is configured in a spool configuration comprising a lower flange configured to facilitate connection to the piston, an upper flange configured to interface with the inner spring and the spring lifter, and a central body connecting the lower flange and the upper flange, the central body being sized to give the piston spacer the desired overall height H_{S}.

11. The valve actuator of claim 10, wherein the upper flange of the piston spacer has an outer diameter that is greater than an inner diameter of the central wall portion of the spring lifter, such that the upper surface of the piston spacer contacts a bottom surface of the spring lifter during downward movement, whereby further downward movement of the spring lifter pushes the piston spacer and the piston downward along the central axis.

12. The valve actuator of claim 11, further comprising:
wherein the flanged rim of the spring lifter is dimensioned to contact an upper surface of the hydraulic cylinder during downward travel of the spring lifter, thereby limiting the downward travel of the spring lifter, and
wherein the inner spring is configured to continue compressing and urging the piston spacer and the piston downward when the spring lifter has reached its lower limit of travel.

13. A fail-safe hydraulic linear actuator for operating a valve, comprising:
a cylindrical spring housing defining a central axis;
an actuator cap secured to an upper end of the spring housing;
a bonnet adapted for connection to the valve and secured to a lower end of the spring housing, the bonnet defining a stem passage therethrough;
a hydraulic cylinder disposed within the spring housing on an upper side of the bonnet;
a piston slidingly mounted within the hydraulic cylinder, the piston and the hydraulic cylinder defining a hydraulic chamber beneath the piston;
a stem extending through the stem passage of the bonnet, the stem having a lower end adapted for connection to the valve and an upper end attached to the piston;
a fluid supply port connecting the hydraulic chamber to an exterior of the actuator for adding and removing hydraulic fluid to and from the hydraulic chamber; and
a dual coil spring fail-safe assembly disposed within the spring housing and biasing the piston and stem toward an extended position, the fail-safe assembly comprising an outer spring and an inner spring disposed concentrically within the outer spring, the outer spring and the inner spring being mechanically connected in series by a spring lifter.

14. The fail-safe hydraulic linear actuator of claim 13, further comprising a pressure relief port connecting the hydraulic chamber to the exterior of the actuator for releasing hydraulic fluid when a pressure in the hydraulic chamber exceeds a predetermined pressure.

15. The fail-safe hydraulic linear actuator of claim 13, further comprising:
a piston spacer disposed between the piston and the fail-safe assembly, the piston spacer having a height H_{S}, and
wherein replacing the piston spacer with a different piston spacer having a different height changes a stroke of the actuator without changing any of
the piston,
the hydraulic cylinder,
the spring lifter, or
the outer spring and inner spring.

16. The fail-safe hydraulic linear actuator of claim 13, further comprising:
wherein the outer spring is a primary coil spring configured to provide a greater portion of a total fail-safe force of the fail-safe assembly, and
the inner spring is a secondary coil spring configured to provide a reserve fail-safe force sufficient to move the piston through its full range of motion upon a failure of the outer spring.

17. The fail-safe hydraulic linear actuator of claim 13, wherein the spring housing and the actuator cap are formed from corrosion-resistant materials suitable for offshore environments, and the outer spring and the inner spring are coil springs formed from Alloy Steel 5160.
